(19) United States
(12) Patent Application Publication
(10) Pub. No.: US 2011/0056823 A1
(43) Pub. Date: Mar. 10, 2011

(54) Methods and apparatus for extracting active ingredients

(76) Inventor: Henry Aoki, Acton, MA (US)

(21) Appl. No.: 12/584,432

(22) Filed: Sep. 4, 2009

(51) Int. Cl. B01D 3/40

(52) U.S. Cl. 203/49; 202/227

(57) ABSTRACT

The present invention provides apparatus and methods for extracting active ingredients from a raw material. The apparatus comprises an atomized water particle production device; an extracting device for bringing a raw material into contact with the atomized water particles so that the atomized water particles trap active ingredients in the raw material; a condensing device for liquefying the atomized water particles that hold the active ingredients; and means for promoting extraction of the raw material. The means for promoting extraction may comprise decompression means for subjecting the raw material within the extracting device to decompression and activation means for activating the raw material.

### BACKGROUND OF THE INVENTION

The present invention relates to methods and apparatus for extracting active ingredients from various raw materials of plant, animal and mineral origin.

A related technique for extracting active ingredients contained in plants or the like is disclosed in Japanese Patent Application Publication No. H09-67259. This related technique is designed to extract a minute amount of active ingredients from plants, animals, minerals, or the like. Based on the foregoing technique, the present inventor established a technique for extracting a minute amount of active ingredients from coffee beans, soybeans or the like.

The active ingredients extracted by the foregoing technique are obtained in solution form. The solution contains only a minute amount of the active ingredients. This makes it difficult to identify the extracted active ingredients. Further, inconvenient handling of the extracted active ingredients restricts the range of applications.

Thus, the present inventor developed a technique for solidifying the extract obtained by the foregoing technique. This solidification technique is disclosed in Japanese Patent Application Publication No. 2003-117307. The solidification technique enables easy specification or identification of the components of the extract, so that the present inventor discovered that a novel functional peptide exists in an extract from coffee beans and that this peptide has anticancer activity and anti-inflammatory activity. This invention is disclosed in Japanese Patent Publication No. 2005-516790.

However, the foregoing conventional techniques have a problem of inefficient extraction. More specifically, a large amount of raw materials are used during many hours of extraction. In addition, the conventional techniques are not able to extract all the ingredients of the raw materials, and cannot solidify the extracted ingredients.

### RELATED PRIOR ART DOCUMENTS

1. JP-A-S63-274402
2. JP-A-H09-67259
3. JP-A-H11-271040
4. JP-A-2002-335862

5. JP-A-2002-226391
6. JP-A-2000-308801
7. U.S. Pat. No. 5,219,758

Objects of the present invention include to:

a: extract active ingredients from a raw material efficiently;

b: extract a wider variety of active ingredients, compared to the conventional techniques; and

c: solidify the extracted active ingredients.

The methods and apparatus of the present invention provide the foregoing and other advantages.

### SUMMARY OF THE INVENTION

In order to solve the problems of the conventional techniques, the present invention provides an apparatus for extracting active ingredients, the apparatus including: an atomized water particle production device; an extracting device for bringing a raw material into contact with the atomized water particles so that the atomized water particles trap active ingredients in the raw material; a condensing device for liquefying the atomized water particles that hold the active ingredients; and means for promoting extraction, in which the means for promoting extraction includes: decompression means for subjecting the raw material within the extracting device to decompression; and activation means for activating the raw material.

In the apparatus for extracting active ingredients, the atomized water particle production device, the extracting device, the condensing device, and the decompression means may be connected to each other through pipes, forming a circulating closed circuit, and the decompression means may be a blower that allows air flow, which contains the atomized water particles, to circulate through the circulating closed circuit.

Further, the activation means for activating the raw material may be a magnetic vibrator. Still further, the activation means for activating the raw material may be an ultrasonic device. Still further, the activation means for activating the raw material may be a magnetizing device.

The extracting device may include: a housing and a raw material container housed in the housing. The housing may be provided with all, or at least one of, the magnetic vibrator, the ultrasonic device, and the magnetizing device, and the raw material container may be made up of meshes.

In the apparatus for extracting active ingredients according to any one of the foregoing embodiments, an additional magnetizing device for applying a magnetic field to water or the atomized water particles is provided.

The extracting device includes the housing and the raw material container housed in the housing. The raw material container is made up of a mesh bag through which air flow that contains the atomized water particles easily passes. The mesh bag stores therein a plant, an animal, or a mineral raw material. The raw material is preferably pulverized into pieces. The atomized water particles flow into the raw material within the extracting device and is brought into contact with the raw material, so that the atomized water particles trap active ingredients in the raw material. At this time, the means for promoting extraction promotes extraction of the active ingredients to a surface of the raw material. The means for promoting extraction includes: the decompression means for subjecting the raw material within the extracting device to decompression; and the activation means for activating the raw material. The means for promoting extraction, having the aforementioned construction, promotes water atomization under decompression, while promoting extraction of the active ingredients to the surface of the raw material by the decompression means and the activation means so that the atomized water particles trap the active ingredients. This allows for high-efficiency extraction of the active ingredients. At the same time, this enables a wider variety of active ingredients to be extracted, compared to the conventional techniques.

The decompression means is a known blower. The blower operates on the circulating closed circuit to subject the raw material within the extracting device to decompression. The circulating closed circuit is formed by connecting the atomized water particle production device, the extracting device, the condensing device, and the decompression means to each other through pipes. The decompression allows the active ingredients in the raw material to be extracted to the surface of the raw material, and then bring them into contact with the atomized water particles.

The extracting device is provided with the activation means for activating the raw material. The activation means includes: at least one of the magnetic vibrator, the ultrasonic device, and the magnetizing device. These devices may each be mounted to the extracting device. Selection of the devices to be used depends on the nature of the raw material. The magnetic vibrator is a known electromagnetic-driven device, and is preferably provided with means for controlling the vibration frequency. When the atomized water particles pass through the extracting device, the housing of the extracting device is vibrated to move the active ingredients in the raw material to its surface, and also to rotate the raw material. This allows the raw material and the atomized water particles to successively change a contact surface therebetween, thus to enhance the extraction efficiency. These successive changes of the contact surface between the raw material and the atomized water particles indicate an increase in contact surface area therebetween, compared to the case where the raw material stays still.

The ultrasonic device may have an oscillator and a vibrator, and is designed both to apply an ultrasonic wave to the raw material and to excite vibrations on the vibrating plate connected to the vibrator, thus to vibrate the raw material. Application of an ultrasonic wave to the raw material results in slight vibrations of the respective pulverized pieces of the raw material, thereby splitting the high molecular weight polymer chains into low molecular weight polymer units and achieving activation within the raw material. Under this condition, when the raw material is subjected to decompression, various active ingredients in the raw material are extracted to the surface of the raw material. This enables a wider variety of active ingredients to be extracted, compared to the conventional techniques.

The vibrating plate may be interposed between the vibrator of the ultrasonic device and the housing of the extracting device to vibrate the housing. This results in the same effect as obtained by the magnetic vibrator.

The extracting device may be provided with an additional magnetizing device for applying a magnetic field to the raw material, water and the atomized water particles. This magnetizing device uses a known magnetic field generator. The magnetizing magnetic field generator may be mounted to the housing of the extracting device, to the atomized water particle production device, and/or at an appropriate location of the circulating closed circuit. The circulating closed circuit is formed by connecting the atomized water particle production device, the extracting device, the condensing device, and the decompression means to each other through the pipes. When a magnetic field is applied to the raw material, the water, and the atomized water particles, the magnetic field acts on the molecules and the electron energy of the raw material, the water, and the atomized water particles. This reduces the size of the molecular clusters of the raw material, the water, and the atomized water particles, and therefore, achieves activation thereof. This allows for efficient extraction of a large variety of active ingredients.

In order to solve the problems of the conventional techniques, the present invention also provides a method for extracting active ingredients, the method including the steps of:

(a) producing atomized water particles;

(b) activating a raw material subjected to decompression to allow active ingredients in the raw material to be extracted to a surface of the raw material;

(c) bringing the raw material into contact with the atomized water particles so that the atomized water particles trap the active ingredients extracted to the surface of the raw material; and

(d) condensing and liquefying the atomized water particles that hold the active ingredients.

In the method for extracting active ingredients, the raw material may be from any one of a plant substance, an animal substance, and a mineral substance.

In the method for extracting active ingredients, some of the atomized water particles, which are not liquefied in the step (d), may be again brought into contact with the raw material, and may then be condensed and liquefied.

The activation means for activating the raw material may include all, or at least one of, magnetic vibration means, ultrasonic means, and magnetizing means.

In the method for extracting active ingredients according to any one of the foregoing embodiments, a magnetic field may be applied to water or the atomized water particles.

The method for extracting active ingredients may further include the step of solidifying the active ingredients in cooled water that is obtained in the liquefying step (d) and that contains an extract from the raw material, the solidifying step including the steps of:

(e) preparing a heated absorbent material;

(f) bringing the extract in the cooled water into contact with the absorbent material by using a vacuum and pressure driving force; and

(g) drying the absorbent material that is wetted in the step (f) in order to produce a solid from the extract, in which the absorbent material may be a hydrophilic filter membrane made of polyvinylidene fluoride and/or a glass fiber membrane, and the absorbent material may be heated before or during absorbing the extract to expand pores of the membrane, thereby to enhance wetting of the absorbent material with the cooled water having the extract in the step (f).

The method for extracting active ingredients may further include the step of adding solvent to the dried extract to again extract the active ingredients from the solvent. The solvent may be water.

In the method for extracting active ingredients, the drying step (g) may be freeze-drying. In the method for extracting active ingredients, the freeze-drying may be carried out at a temperature ranging from between about −10 degree Celsius to −70 degree Celsius.

The present invention, which has the construction and operates as described above, allows for efficient extraction of a wider variety of active ingredients from various substances, compared to the conventional techniques. More specifically, the present invention allows a minute amount of active ingredients present in plant, animal, mineral or other substances to be efficiently extracted therefrom without impairing the natural functionality of the active ingredients. The present invention also allows the active ingredients to be obtained in solid form.

### BRIEF DESCRIPTION OF THE DRAWINGS

The present invention will hereinafter be described in conjunction with the appended drawing figures, wherein like reference numerals denote like elements, and:

FIG. 1 is a block diagram illustrating an example embodiment of an apparatus for extracting active ingredients according to the invention;

FIG. 2 is a side view of an example embodiment of an apparatus for extracting active ingredients according to the invention;

FIG. 3 is an external perspective view of an example embodiment of an extracting device according to the invention;

FIG. 4 is a cutaway side view of the extracting device according to one example embodiment of the invention;

FIG. 5 is a cutaway side view of the extracting device according to another example embodiment of the invention; and

FIG. 6 is a cutaway side view of the extracting device according to a further example embodiment of the invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

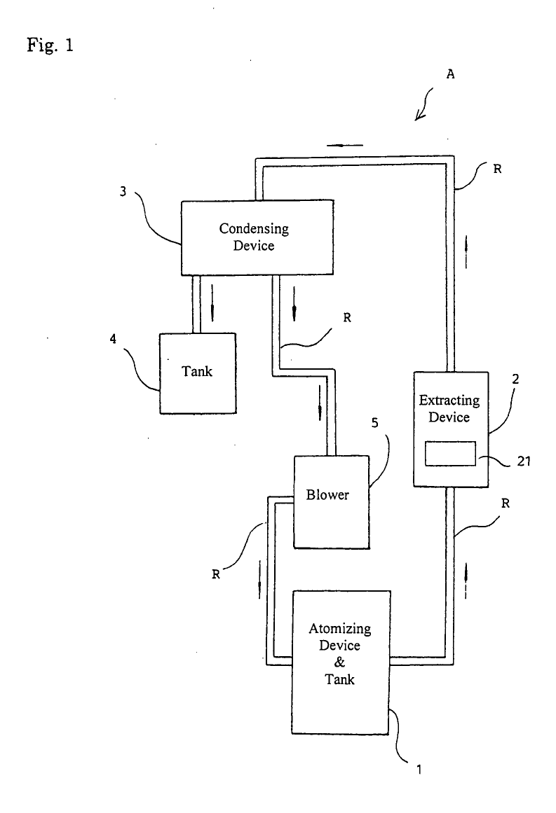

With reference to the accompanying drawings, exemplary embodiments of the present invention will be described below. FIG. 1 is a block diagram illustrating a construction of an apparatus A for extracting active ingredients according to one embodiment of the invention. In FIG. 1, a reference numeral 1 represents an atomized water particle production device or an atomized water particle production tank. A reference numeral 2 represents an extracting device. The atomized water particle production tank 1 delivers atomized water particles to the extracting device 2. The extracting device 2 uses the atomized water particles to extract active ingredients from a plant, an animal or a mineral raw material that is pulverized into pieces. The extracting device 2 includes activation means 21 for activating the raw material.

Reference numerals 3, 4, and 5 represent a condensing device, a tank, and a blower, respectively. The condensing device 3 is designed to liquefy the atomized water particles that are delivered from the extracting device 2 and that hold the active ingredients of the raw material. The tank 4 is designed to reserve active ingredient containing water that is liquefied by the condensing device 3 and that contains the active ingredients of the raw material. The blower 5 is provided between the atomized water particle production device 1 and the condensing device 3, and is designed to function as decompression means. As shown in FIG. 1, the atomized water particle production device 1, the extracting device 2, the condensing device 3, and the blower 5 as the decompression means are connected to each other through pipes, forming a circulating closed circuit R. When the blower 5 operates, air flow that contains the atomized water particles circulates through the circulating closed circuit R.

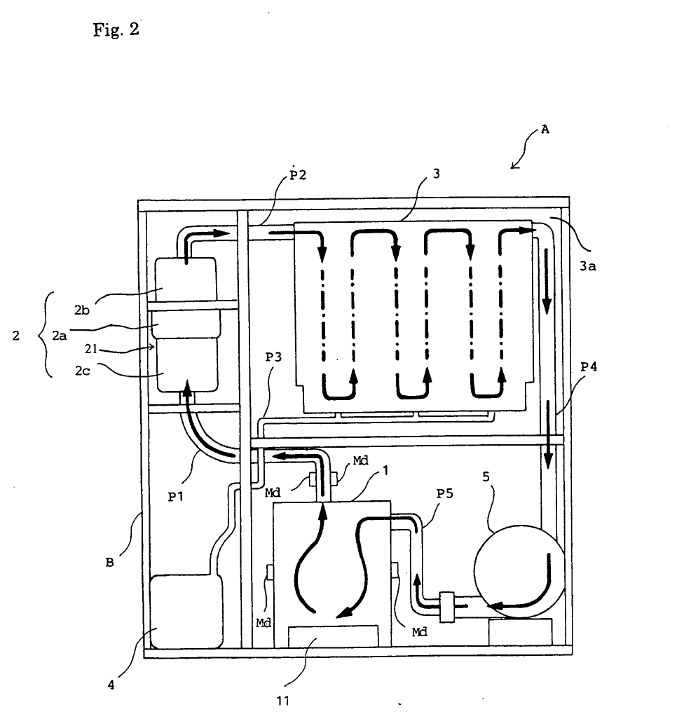

FIG. 2 is a side view of an example embodiment of the apparatus A for extracting active ingredients that has the aforementioned construction. As shown in FIG. 2, the atomized water particle production device 1 is a water tank, which may be made of stainless steel and have, for example, a width of 35 cm, depth of 60 cm, and height of 35 cm. The water tank 1 is designed to reserve 30 to 40 liters of water constantly during the operation. The water tank 1 may have an ultrasonic generator in which ultrasonic vibrators are provided at the bottom of the water tank 1. Each ultrasonic vibrator is capable of atomizing about 0.5 liter of water per hour. The ultrasonic generator has functions of water atomization and activation. In the water tank 1, a heater may also be provided to heat the water to a predetermined temperature.

The extracting device 2 is provided on a side wall of a frame body B. The extracting device 2 is connected to the water tank 1 or the atomized water particle production device through a flexible plastic pipe P1. A reference numeral and symbol P2 represents a flexible pipe that connects the extracting device 2 to the condensing device 3.

The condensing device 3 includes plural condensing tubes. The condensing device 3 may be provided in a cooling chamber 3a inside of the frame body B, and is connected to the extracting device 2 located outside of the cooling chamber 3a through the pipe P2. The condensing device 3 is designed to drop the active ingredient containing water to the tank 4 through a pipe P3. The pipe P3 is connected to the bottom of the condensing device 3. The tank 4 is designed to reserve the active ingredient containing water. The condensing device 3 is connected to the blower 5 as the decompression means through a pipe P4. The blower 5 allows some of the atomized water particles, which are not condensed in the condensing device 3, to be recycled to the water tank 1 or the atomized water particle production device through a pipe P5.

The aforementioned pipes P1, P2, P4, and P5 form the circulating closed circuit R. When the blower 5 as the decompression means operates, the air flow that contains the atomized water particles circulates through the circulating closed circuit R as shown by the arrows in FIG. 2.

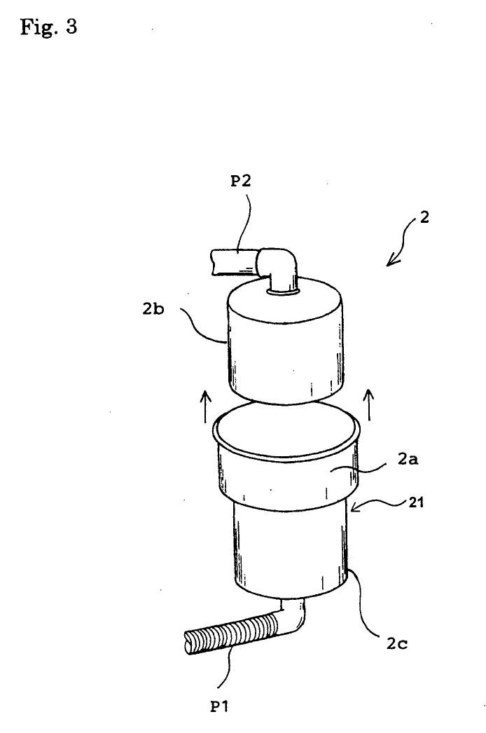

FIG. 3 is an external perspective view of an example embodiment of the extracting device 2. In FIG. 3, a reference numeral and symbol 2a represents a cylindrical housing having a mesh bottom. The housing 2a houses therein a raw material container 6 made up of meshes. The raw material container 6 stores a raw material therein. A reference numeral and symbol 2c represents a first collection cylinder which receives the atomized water particles from the tank 1. The activation means 21 for activating the raw material is provided below the housing 2a. For example, the first collection cylinder 2c may include the activation means 21. A reference numeral and symbol 2b represents a second collection cylinder designed to deliver the atomized water particles from the housing 2a to the pipe P2. The second collection cylinder 2b is interposed between the housing 2a and the pipe P2.

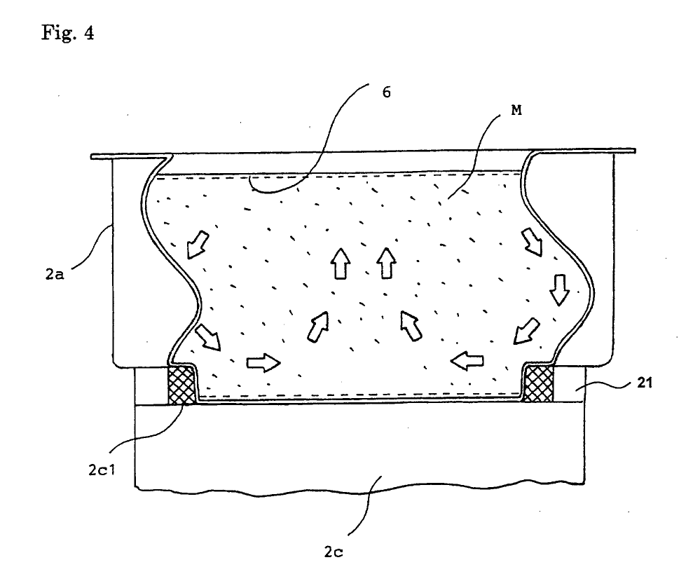

FIG. 4 is a cutaway side view of the extracting device 2 according to one example embodiment of the invention. The housing 2a has the mesh bottom through which the atomized water particles pass. The raw material container 6 made up of meshes is designed to store a raw material, and is housed in the housing 2a. In this embodiment of the invention, the activation means 21 is a known magnetic vibrator with a vibrating plate 2c1. Under the action of the ring-shaped vibrating plate 2c1, a raw material M in the raw material container 6 rotates as shown by the arrows in FIG. 4. Thus, when the atomized water particles pass through layers of the raw material M in the raw material container 6, the atomized water particles contact with the entire surface of each pulverized piece of the raw material M, for example, coffee beans. This extremely increases the efficiency of trapping active ingredients in the raw material. In addition, the synergy between high-speed micro vibrations of the magnetic vibrator and decompression promotes extraction of various active ingredients in the raw material to the surfaces of the pulverized pieces of the raw material. This enables the atomized water particles to trap a wider variety of active ingredients, compared to the conventional techniques.

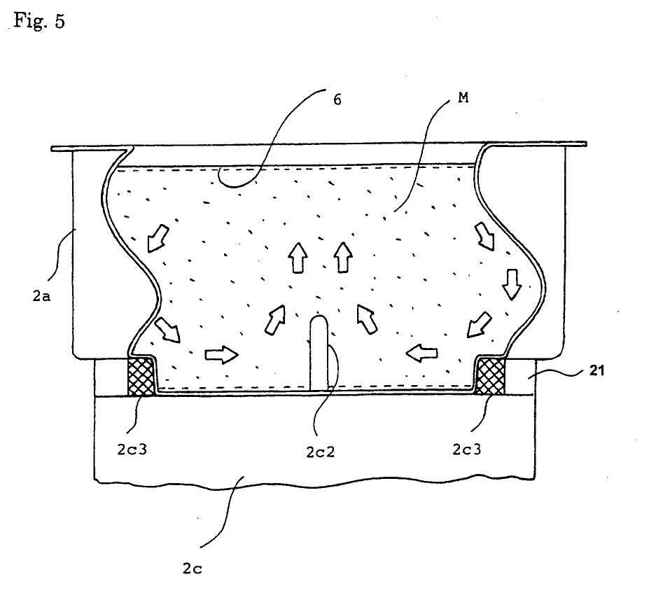

FIG. 5 is a side view of the extracting device 2 according to another embodiment of the invention. In this embodiment of the invention, the activation means 21 is a known ultrasonic generator. The ultrasonic generator as the activation means 21 has an ultrasonic radiator 2c2 and an ultrasonic vibrating plate 2c3. The ultrasonic generator 2c2 stands at the mesh bottom of the housing 2a and protrudes toward the raw material M in the raw material container 6 made up of meshes. The ultrasonic vibrating plate 2c3 has a ring shape and is provided on the periphery of the bottom of the housing 2a. Either ultrasonic radiation or ultrasonic vibration, or both ultrasonic radiation and ultrasonic vibration may be selectively applied to the raw material M. Operation of the ultrasonic generator as the activation means 21 results in the same effect as obtained by operation of the magnetic vibrator. Especially, an ultrasonic wave is radiated to the raw material M, thereby splitting the high molecular weight polymer chains within the raw material M, and thus achieving activation within the raw material M. This promotes extraction of the active ingredient to the surface of the raw material M, and therefore, enables the atomized water particles to trap a wider variety of active ingredients, compared to the conventional techniques.

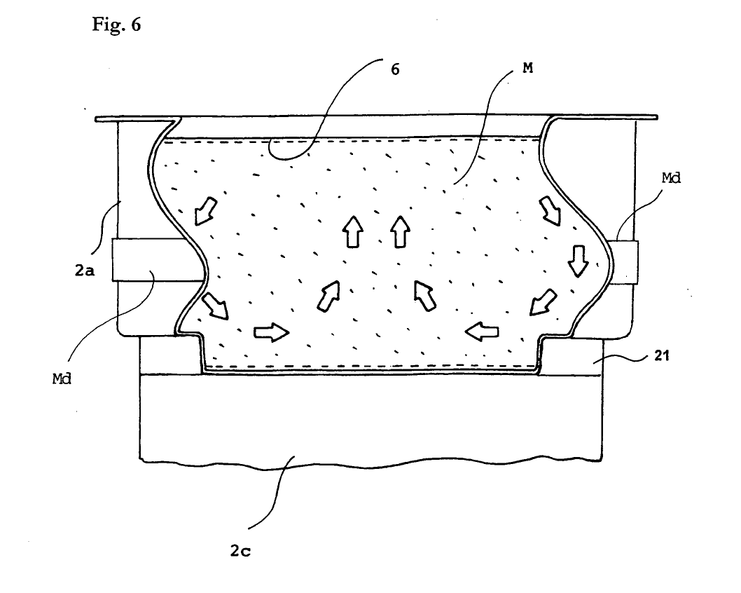

FIG. 6 is a side view of the extracting device 2 according to a f embodiment of the invention. The extracting device may be provided with a magnetizing device Md (either with or without the activation device 21 present). The magnetizing device Md uses a magnetic field generator, such as an electromagnet and a permanent magnet. The magnetic field generator is provided to the housing 2a of the extracting device. A magnetizing device Md with a magnetic field generator may be additionally mounted to the water tank 1 and/or at an appropriate location of the circulating closed circuit R (e.g., as shown in FIG. 2). When a magnetic field is applied to the raw material, the water, and the atomized water particles, the magnetic field acts on the molecules and the electron energy of the raw material, the water, and the atomized water particles. This reduces the size of the molecular clusters of the raw material, the water, and the atomized water particles, and therefore, achieves activation thereof. This allows for efficient extraction of a large variety of active ingredients.

With reference to FIGS. 1, 2, and 3, operation of the apparatus for extracting active ingredients will be described below, in combination with a method for extracting active ingredients according to an example embodiment of the invention. In this embodiment, raw coffee beans are used as a raw material M. Those skilled in the art will appreciate the invention may be used to extract ingredients from other raw materials.

First the coffee beans M are pulverized into pieces as small as rice grains. The pulverized pieces are stored in the raw material container 6 made up of meshes. This raw material, container 6 is loaded in the housing 2a.

Then, 30 to 50 liters of water is reserved in the water tank 1 or the atomized water particle production device shown in FIG. 2. The water tank 1 is designed to automatically maintain the aforementioned amount of water. When the water and coffee beans (or other raw material) are prepared in the water tank 1 and in the extracting device 2, respectively, the heater provided in the water tank 1 heats the water therein to a predetermined temperature.

In the event of using coffee beans as a raw material, the predetermined temperature of 85° c. is found optimal empirically. The predetermined temperature of 85° c. is optimal for maintaining the temperature within the extracting device 2 at 60 to 70° c., as will be described later.

When the water temperature within the water tank 1 reaches the predetermined temperature of 85° c., the ultrasonic generator provided in the water tank 1 is switched ON, while the blower 5 as the decompression means is switched ON.

When the blower 5 operates, air flow circulates through the water tank 1, the extracting device 2, the condensing device 3, the blower 5, and the circulating closed circuit R formed by the connecting pipes that connect these devices to each other.

Together with the air flow, the atomized water particles produced in the water tank 1 pass through the aforementioned pipe P1 and reach the extracting device 2. A temperature of the atomized water particles in the extracting device 2 preferably falls within a range of 60 to 70° c., as mentioned above. A temperature sensor may be mounted to the extracting device 2 to constantly detect the temperature within the extracting device 2. In order to obtain the preferable temperature, the water temperature within the water tank 1 is controlled depending on the detection results.

As mentioned above, when the blower 5 operates, air flow circulates through the respective devices. The air flow passes through the pipe P1 and reaches the extracting device 2 where the raw material or coffee beans are filled. Thus, the air flow receives resistance from the extracting device 2 and is prevented from passing therethrough. In contrast, nothing prevents the air flow from passing through the circulating closed circuit R from the connecting pipe P2 and the following pipes. Thus, a space within the extracting device 2 is under a decompressed condition. In combination with the decompressed condition, the coffee beans filled in the housing 2a of the extracting device are activated by the activation means 21 (e.g., magnetic vibration, ultrasonic vibration, ultrasonic radiation, and/or magnetic field application).

When the raw material is activated in the decompressed space within the extracting device 2, various kinds of active ingredients contained in the raw material or coffee beans are extracted to the surfaces of the pulverized pieces of the coffee beans. By vibrating the raw material, the atomized water particles are brought into contact with the entire surface of each pulverized piece of the coffee beans. When passing through the layers of the raw material, the atomized water particles efficiently traps the various kinds of active ingredients extracted to the surfaces of the pulverized pieces of the coffee beans. As described above, the temperature within the extracting device, more specifically, the temperature within the housing 2a is maintained at around 65° c. This prevents the active ingredients contained in the coffee beans from being destroyed by heat, and therefore allows the active ingredients to be extracted into the atomized water particles.

While holding the active ingredients of the coffee beans, the atomized water particles pass together with the air flow through the connecting pipe P2 and reach the respective condensing tubes of the condensing device 3. The condensing device 3 is provided in the cooling chamber 3a within which the condensing tubes and a cooler of the condensing device 3 are cooled. Thus, some of the atomized water particles contact with the condensing tubes and the cooler, and are liquefied into water that contains the active ingredients of the coffee beans. The water that contains the active ingredients of the coffee beans drops to the tank 4 and is reserved in the tank 4.

In contrast, some of the atomized water particles may not be liquefied in the condensing device 3, and pass together with the air flow through the connecting pipe P4. These atomized water particles are sucked by the blower 5, and then recycled to the water tank 1. After that, the atomized water particles are delivered again to the extracting device 2 through the connecting pipe P1.

As mentioned above, when circulating through the circulating closed circuit R, the atomized water particles trap the active ingredients of the raw material or coffee beans. These atomized water particles are liquefied to obtain water that contains the active ingredients of the coffee beans. The duration of a single operation of the apparatus is approximately one hour. More specifically, in the foregoing example embodiment, approximately 1,800 grams of pulverized pieces of coffee beans are used during a one-hour extraction. This results in producing approximately 3 to 4 liters of water that contains the extracted ingredients.

The final product obtained in the tank 4 via the condensing device 3 is a colorless, transparent, and clear liquid. The extract (active ingredients) in the final liquid product is solidified in accordance with one of the processes of the present invention. In one embodiment of the invention, the extract is solidified according to the following procedure. A non-nutritional adsorbent material is used. Suitable absorbent materials include a hydrophilic filter membrane, such as a polyvinylidene fluoride membrane, and membranes of glass fiber, cotton, nylon, cellulose, and tea bag paper. The form of the membrane is not particularly limited, and includes a sheet and a disk. Membrane material selection depends on the process for analyzing the extract (active ingredients) of the final product.

The absorbent material contacts with the extract. Preferably, the entire surface of the absorbent material is wetted with the final liquid product that holds the extract. If the absorbent material used is a membrane material, the membrane material is completely wetted with the final product (extract), for example, by using a driving force of a vacuum pump to vacuum or pressure the final product (extract) through the membrane material. The membrane material can be optionally heated before or while being wetted with the final product (extract) to expand pores of the membrane and to enhance wetting.

Alternatively or in addition, the final product (extract) can be heated alone or together with the absorbent material.

Once the absorbent material is sufficiently wetted with the final product (extract), the extract is preferably dried and adhered to the absorbent material. The extract may be dried by freeze-drying, heat-drying or air-drying. The freeze-drying may be particularly preferred.

The dried extract may be preserved for significant lengths of time without deterioration of the extract. Also, this dried extract can be dissolved in water or other suitable solvent, resulting in the dissolution of the extract's active ingredients in the water or the solvent.

Increased pressure can be used to facilitate dissolution, if desired. The dried extract is subjected to analysis, particularly, analysis for pharmaceutical research and development. If the absorbent material used is a paper, the dried extract can be dissolved in water and ingested as a health drink.

In another embodiment of the present invention, a food material is used as an alternative to the absorbent material. More specifically, the food material is wetted with the final liquid product (extract). The food material is of plant or animal origin (including but not limited to meat), or of grain or vegetable origin. The food material is not limited to a particular form, but may be in any form, including chunks, slices, powder, pieces or granules. The food material is wetted by spraying the final product (extract) onto the food material, or by soaking the food material in the final product (extract). Then, the soaked or wetted food material is dried, such as by air-drying, freeze-drying or heat-drying. This results in a healthy food that contains the active ingredients of the extract.

In either of the above embodiments, in the event when freeze drying is used, the freeze drying process is preferably carried out at a temperature ranging from −10 degree Celsius to −70 degree Celsius and at a vacuum of 5.3 cfm to 23 cfm displacement.

Those skilled in the art will appreciate that the temperature and the vacuum can vary depending upon the nature of the raw material and the size of the raw material, as well as the particular freeze dryer used. The amount of time the raw material is subjected to freeze-drying can be readily determined by the skilled artisan, and can depend in part on the concentration of the raw material. The resulting dried product can be preserved for long lengths of time, spanning many days or months, without deleteriously affecting the quality or taste of the product.

Indeed, the taste of the resulting product, upon reconstitution with water or other solvent, is enhanced compared to the original raw material. Transportation and storage are facilitated and made more cost effective. The active ingredients in the extract, which may be otherwise destroyed by heating, are preserved by using the extraction process detailed above.

The freeze-dried product also has a longer shelf life than the liquid extract, and lends itself to chemical identification and testing.

The freeze-dried product can be reconstituted simply by adding a solvent, preferably water, to the product. The amount of solvent to be added is not particularly limited, and depends on the desired concentration of extract in the final potable liquid. The freeze-dried product can be used (i.e., without reconstitution) as an additive for or with other foods, such as a garnish for salad, a dried soup ingredient, or mixed with other food ingredients.

The present invention, which has the construction and operates as described above, allows a wider variety of active ingredients to be extracted from various substances, compared to the conventional techniques. The present invention also allows for efficient and high-speed extraction of these ingredients at a low temperature. Furthermore, the present invention allows for solidification of the active ingredients extracted from various substances so that the solid active ingredients are used in a wide variety of applications.

It should now be appreciated that the present invention provides advantageous methods and apparatus for extracting active ingredients.

Although the invention has been described in connection with various illustrated embodiments, numerous modifications and adaptations may be made thereto without departing from the spirit and scope of the invention as set forth in the claims.

What is claimed is:

1. An apparatus for extracting active ingredients, comprising:
an atomized water particle production device for producing atomized water particles;
an extracting device for bringing a raw material into contact with the atomized water particles, enabling the atomized water particles to trap active ingredients from a surface of the raw material;
a condensing device for liquefying the atomized water particles that hold the active ingredients; and
means for promoting extraction of the raw materials from the liquefied atomized water particles, said the means for promoting extraction comprising:
decompression means for subjecting the raw material within the extracting device to decompression; and
activation means for activating the raw material.

2. The apparatus for extracting active ingredients according to claim 1, wherein:
the atomized water particle production device, the extracting device, the condensing device, and the decompression means are connected to each other through pipes, forming a circulating closed circuit; and
the decompression means comprises a blower that allows air flow to circulate through the circulating closed circuit.

3. The apparatus for extracting active ingredients according to claim 1, wherein the activation means for activating the raw material comprises a magnetizing device.

4. The apparatus for extracting active ingredients according to claim 1, wherein the activation means for activating the raw material comprises an ultrasonic device.

5. The apparatus for extracting active ingredients according to claim 1, wherein the activation means for activating the raw material comprises a magnetic vibrator.

6. The apparatus for extracting active ingredients according to claims 1, wherein:
the activation means for activating the raw material comprises at least one of a magnetizing device, an ultrasonic device, and a magnetic vibrator;
the extracting device comprises a housing and a raw material container housed in the housing;
the housing is provided with at least one of the magnetizing device, the ultrasonic device, and the magnetic vibrator; and
the raw material container is made up of meshes.

7. The apparatus for extracting active ingredients according to claims 1, wherein a magnetizing device for applying a magnetic field to water or the atomized water particles is provided.

8. A method for extracting active ingredients, comprising:
producing atomized water particles;
activating a raw material subjected to decompression to allow active ingredients in the raw material to be extracted to a surface of the raw material;
bringing the raw material into contact with the atomized water particles so that the atomized water particles trap the active ingredients extracted to the surface of the raw material; and
condensing and liquefying the atomized water particles that hold the active ingredients.

9. The method for extracting active ingredients according to claim 8, wherein the raw material is from one of a plant substance, an animal substance, and a mineral substance.

10. The method for extracting active ingredients according to claim 8, wherein some of the atomized water particles, which are not liquefied in the condensing and liquefying step, are again brought into contact with the raw material, and are then condensed and liquefied.

11. The method for extracting active ingredients according to claim 8, wherein the raw material is activated by at least one of a magnetic vibration means, an ultrasonic means, and a magnetizing means.

12. The method for extracting active ingredients according to claim 8, wherein a magnetic field is applied to water or to the atomized water particles.
